(19) United States
(12) Patent Application Publication
(10) Pub. No.: US 2010/0332517 A1
(43) Pub. Date: Dec. 30, 2010

(54) ELECTRONIC DEVICE AND METHOD FOR DISPLAYING IMAGE CORRESPONDING TO PLAYING AUDIO FILE THEREIN

(75) Inventors: TENG-YU TSAI, Tu-Cheng (TW); JYH-GWO JU, Tu-Cheng (TW); CHIA-PENG WANG, Tu-Cheng (TW); CHUN-WEN WANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/609,210

(22) Filed: Oct. 30, 2009

(30) Foreign Application Priority Data
Jun. 26, 2009 (CN) 200910303706.4

(51) Int. Cl. G06F 3/16; G06F 17/30

(52) U.S. Cl. 707/769; 700/94; 707/E17.108; 707/E17.115; 707/E17.009; 707/E17.02

(57) ABSTRACT

An electronic device includes an audio playing module, an audio file analyzing module, an image fetching module and a display. The audio playing module is used for playing an audio file. The audio file analyzing module is capable of analyzing a tag corresponding to the audio file to obtain a keyword associated with the audio file. The image fetching module is capable of acquiring an image corresponding to the audio file according to the keyword. The display is capable of displaying the image when the audio file is being played by the audio playing module.

### BACKGROUND

1. Technical Field

The present disclosure relates to electronic devices and methods for displaying images corresponding to currently playing audio files in the electronic device.

2. Description of Related Art

Embedded electronic devices, for example, digital photo frames (DPFs) are becoming increasingly popular due to their convenience and ease of manipulation when implementing particular functions. However, when a song is played on the electronic device, only a user interface is displayed on a display of the electronic device. The visual effect on the display may be boring to the user.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of an electronic device.

FIG. 2 is a flowchart of a method for displaying an image corresponding to a currently playing audio file in the electronic device.

FIG. 3 is a schematic view of a user interface for displaying the image.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

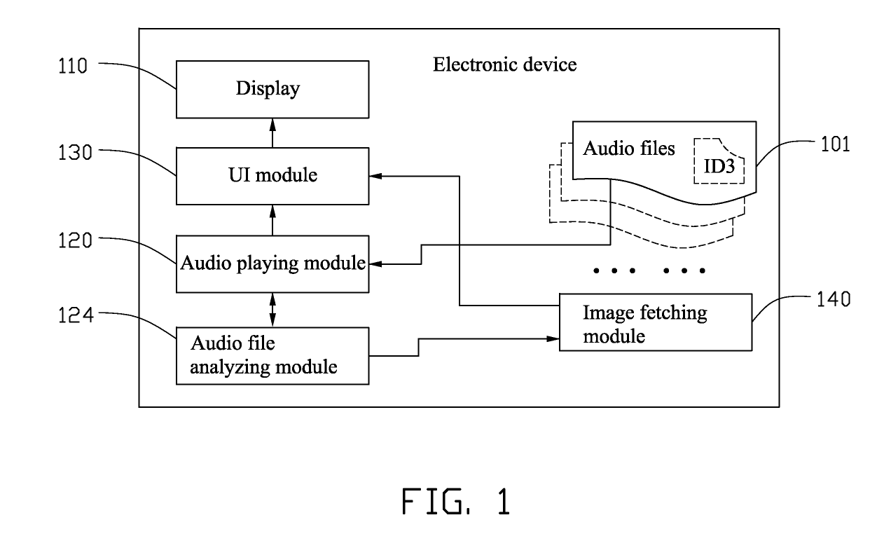

Referring to FIG. 1, an electronic device 100 is an embedded electronic device, such as a digital photo frame (DPF). The electronic device 100 includes a display 110, a user interface (UI) module 130, an audio playing module 120, an audio file analyzing module 124, and an image fetching module 140. A plurality of audio files 101 is stored in the electronic device 100. The audio files 101 can be music files, such as in MP3, WMA, or other audio formats. Some of the audio files 101 such as MP3 audio files 101, may include embedded ID3 tags. Each ID3 tag includes a title, an artist and an album name or other corresponding information.

When one of the audio files 101 is loaded by the audio playing module 120 to play, the audio file analyzing module 124 may analyze the loaded audio file 101 to obtain a keyword corresponding to the loaded audio file 101. The audio file analyzing module 124 may analyze a file name of the loaded audio file 101 or an embedded ID3 tag. The image fetching module 140 can search on the Internet according to the keyword to fetch an image corresponding to the loaded audio file 101. The image corresponding to the loaded audio file 101 may be a photograph of the singer or an album image of the loaded audio file 101. In the embodiment, the image is an album cover of the loaded audio file 101.

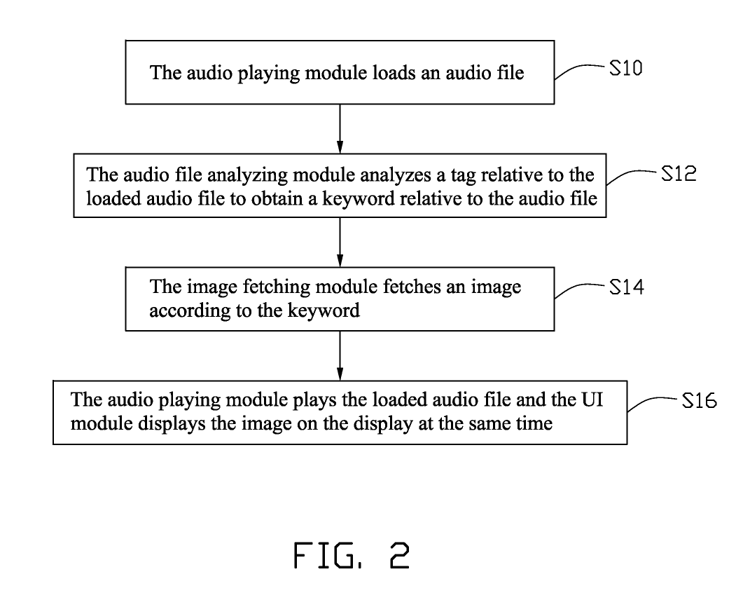

Referring to FIG. 2, a method for displaying an image corresponding to a currently playing audio file includes the following steps.

In step S10, the audio playing module 120 loads an audio file 101.

In step S12, the audio file analyzing module 124 analyzes the loaded audio file 101 to obtain a keyword corresponding to the audio file. The audio file analyzing module 124 analyzes the loaded audio file 101 include analyzes a file name of the loaded audio file 101 or an ID3 tag embedded in the loaded audio file 101. If the file name is analyzed, this step further includes the audio file analyzing module 124 splits the file name to obtain the keyword. If the ID3 tag is analyzed, this step further includes the audio file analyzing module 124 parsing the ID3 to obtain the keyword.

In step S14, the image fetching module 140 searches and fetches an image according to the keyword. The image fetching module 140 searches the Internet according to the keyword to acquire the image. The image fetching module 140 can further search the image at an image search website and download the image according to a valid image Uniform Resource Locator (URL).

In step S16, the audio playing module 120 plays the loaded audio file 101 and the UI module displays the image on the display 110 at the same time.

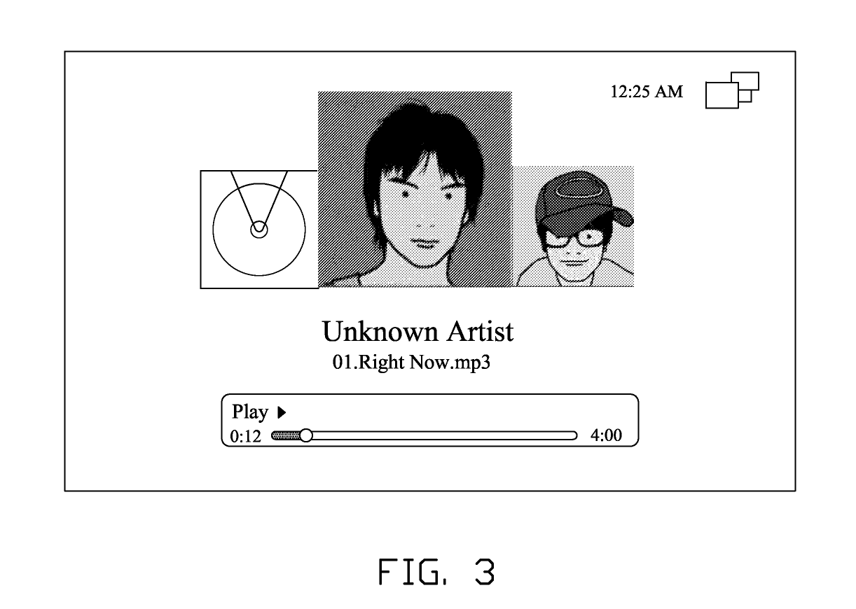

Referring to FIG. 3, a visual effect of the image and a UI is displayed. The user can enjoy the music and the corresponding image on the display 110 at the same time.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. An electronic device, comprising:
an audio playing module for playing an audio file;
an audio file analyzing module capable of analyzing the audio file to obtain a keyword associated with the audio file;
an image fetching module capable of searching and, if found, acquiring an image corresponding to the audio file according to the keyword; and
a display capable of displaying the image when the audio file is being played by the audio playing module.

2. The electronic device of claim 1, wherein the electronic device is an embedded electronic device.

3. The electronic device of claim 1, wherein the audio file analyzing module is capable of analyzing a file name of the audio file to obtain the keyword.

4. The electronic device of claim 1, wherein the audio file includes an embedded ID3 tag, the ID3 tag includes at least one of a title, an artist and an album name.

5. The electronic device of claim 1, wherein the image fetching module is capable searching the Internet according to the keyword.

6. The electronic device of claim 5, wherein the image fetching module is capable of searching for the image at an image search website and downloading the image according to a valid image Uniform Resource Locator.

7. The electronic device of claim 1, wherein the image is an album cover of the audio file.

8. A method for displaying an image corresponding to a being played audio file in an electronic device, comprising:
loading an audio file to an audio playing module;
analyzing the loaded audio file to obtain a keyword corresponding to the audio file;
searching and fetching an image according to the keyword; and
playing the audio file by the audio playing module and displaying the image on a display at the same time.

9. The method of claim 8, wherein fetching the image further comprises searching the Internet according to the keyword to fetch the image.

10. The method of claim 9, wherein searching the Internet further comprises searching the image at an image search website and downloading the image according to a valid image Uniform Resource Locator.

11. The method of claim 8, wherein the electronic device is an embedded electronic device.

12. The method of claim 8, wherein analyzing the loaded audio file further comprises analyzing a file name of the audio file.

13. The method of claim 8, wherein the audio file includes an embedded ID3 tag, the ID3 tag includes one of a title, an artist, and an album name; and analyzing the loaded audio file further comprises analyzing the ID3 tag.

14. The method of claim 8, wherein the image is an album cover of the audio file.

15. A method for displaying an image corresponding to a being played audio file in an electronic device, comprising:
providing an audio playing module; an audio file analyzing module capable of analyzing the audio file to obtain a keyword associated with the audio file; an image fetching module capable of searching and, if found, acquiring an image corresponding to the audio file according to the keyword; and a display capable of displaying the image when the audio file is being played by the audio playing module;
loading the audio file to the audio playing module;
analyzing the loaded audio file to obtain the keyword corresponding to the audio file;
searching and fetching the image according to the keyword; and
playing the audio file by the audio playing module and displaying the image on the display at the same time.
